(19) United States
(12) Patent Application Publication
(10) Pub. No.: US 2023/0069529 A1
(43) Pub. Date: Mar. 2, 2023

(54) Modular, Multi-Configurable Mud Flap System

(71) Applicant: Duraflap LLC, Medford, OR (US)

(72) Inventor: William Dennis PERRY, Medford, OR (US)

(73) Assignee: Duraflap LLC, Medford, OR (US)

(21) Appl. No.: 17/412,166

(22) Filed: Aug. 25, 2021

(51) Int. Cl. B62D 25/16

(52) U.S. Cl. CPC B62D 25/163

(57) ABSTRACT

Multi-part mud flap adapters include a mounting bracket and a shaped cowling that integrates with and continues styling lines of the vehicles fenders, flares and trim to allow replaceable mud flaps to be secured to wheel wells, with the front face of the mud flap approximately tangent to the curve of the wheel well so that the mud flap does not reduce tire clearance.

### CONTINUITY AND CLAIM OF PRIORITY

This is an original U.S. patent application.

### FIELD

The invention relates to mounting systems for vehicle accessories. More specifically, the invention relates to stylistically integrated mounts for replaceable mud flaps.

### BACKGROUND

Many vehicle owners and operators choose to install mud flaps to protect vehicle surfaces from gravel, dirt, ice and mud flung up by vehicle tires. Mud flaps also help control road debris that can damage other vehicles or injure other drivers.

### SUMMARY

A mudflap adapter system for a vehicle includes a mounting bracket and a cowling or fairing that is shaped to extend styling lines of the vehicle's fenders and bodywork. The cowling covers the mounting bracket, and both are secured to the vehicle using fasteners. A replaceable mudflap is secured to the mounting bracket and cowling with a second set of fasteners.

### BRIEF DESCRIPTION OF DRAWINGS

FIG. 1 is a view of an embodiment from one perspective.

FIG. 2 is a view of the embodiment from another perspective.

FIG. 3 shows a vehicle fender, wheel and prior-art mud flap.

FIG. 4 shows an alternate arrangement of fender and mud flap.

FIG. 5 shows another alternate arrangement of fender and mud flap.

FIG. 6 shows a fender, mud flap and trim cowling.

FIG. 7 is an exploded view of an embodiment.

FIG. 8 is an internal side view of an embodiment showing where a mud flap may be mounted.

FIGS. 9 and 10 are internal and external side views of an embodiment.

FIGS. 11 and 12 are top and bottom views of an embodiment.

FIGS. 13 and 14 are front and rear views of an embodiment.

FIG. 15 shows several differently-shaped mudflaps that may be used with an embodiment.

### DETAILED DESCRIPTION

Embodiments of this invention are adapter structures to provide secure, multi-point mounting locations for installing replaceable mud flaps near the rear area of a vehicle wheel well. The structures comprise a shaped, non-structural cowling whose outer surface matches or complements the vehicle styling lines and/or adjacent fender flares, protectors or similar vehicle body parts.

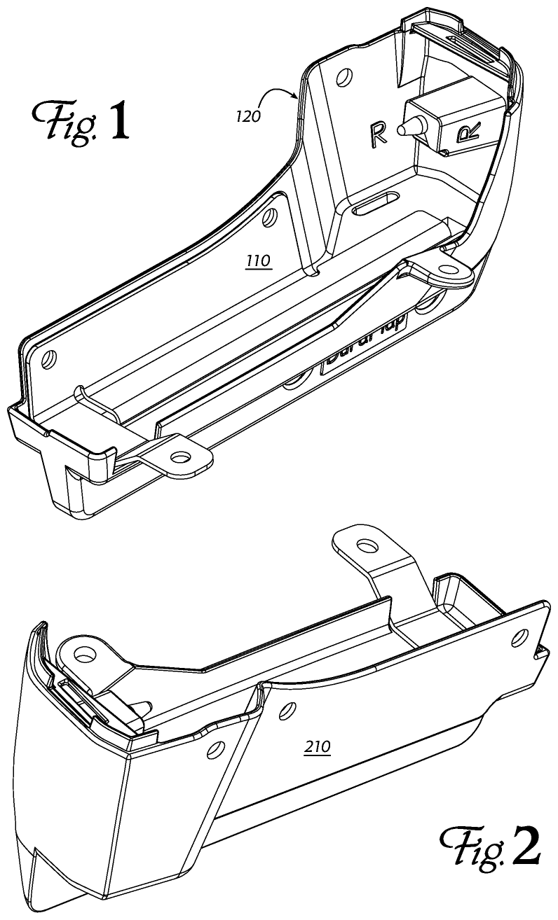

FIG. 1 shows an embodiment of the invention that is of suitable size and shape to fit the right front fender/wheel well of a GMC Sierra truck. Embodiments for other vehicles (and even embodiments suitable for the left and rear wheel wells of the GMC Sierra) would be shaped and sized differently, but these other embodiments would share the distinguishing features and characteristics described here. An embodiment comprises a sturdy mounting bracket 110 and a contoured shell 120 that covers at least a substantial portion of the mounting bracket.

FIG. 2 shows a different view of the embodiment of FIG. 1. The surface marked as 210 is flush with the inner surface of the right front wheel well when the embodiment is installed. For this vehicle, an embodiment replaces a plastic splash guard that is provided as standard equipment. The contoured shell is shaped similarly to the OEM splash guard over a substantial portion of its surface, but is shaped differently in other areas to provide the mud-flap mounting features described below.

FIG. 3 shows a simplified, representative side view of a front wheel well of a vehicle. The wheel well is formed in the front fender 310. The front wheel 320 is visible through a roughly semicircular arch 330 that marks the outside edge of the wheel well. A prior-art mud flap 340 may be secured to the aft portion of the wheel well by suitable fasteners 350. Note that in this arrangement, the mud flap consumes some space that would otherwise be open between the tire and the inside of the wheel well. This may be significant if oversized wheels or tires are in use; the mud flap may contact the tire under some suspension and/or steering positions. Such contact is undesirable.

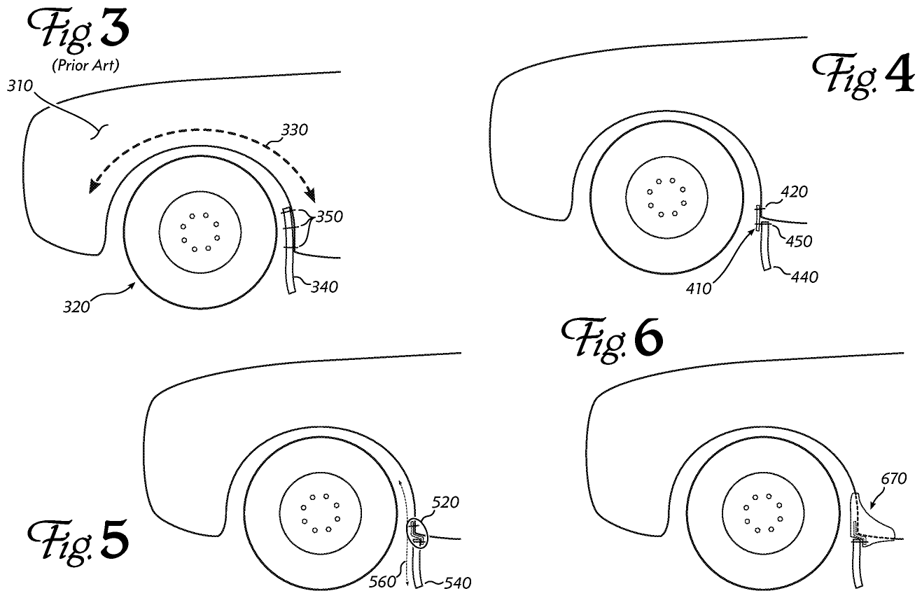

FIG. 4 shows another arrangement by which a mud flap 440 may be secure to the aft portion of the wheel well. Here, a bracket 410 is secured to the wheel well by a fastener 420, and the mud flap 440 is secured to the bracket 410 (rather directly than to the wheel well) by a second fastener 450. This arrangement can reduce the mud flap's intrusion into the wheel well because the bracket 410 may be thinner than the mud flap 440.

FIG. 5 shows another arrangement that is similar to FIG. 4. Here, bracket 520 has a zig-zag bend, so that mud flap 540 can be secured to the forward face of the bracket and yet the forward face of mud flap 540 is roughly tangent with the inner surface of the wheel well (as indicated by dotted line 560). The bent bracket 520 may be stiffer than a simple planar bracket (as FIG. 4 at 410) so this mounting arrangement may be sturdier.

Finally, FIG. 6 shows how a shaped cowling 670 may be placed over a bracket and mudflap system like FIG. 5 to protect the hardware and to provide improved stylistic integration to the overall installation. FIG. 6 is a simple, representative embodiment of the present invention because it comprises a bracket and a cowling, and provides features for mounting a mud flap so that its forward face is roughly tangent to the interior surface of the wheel well.

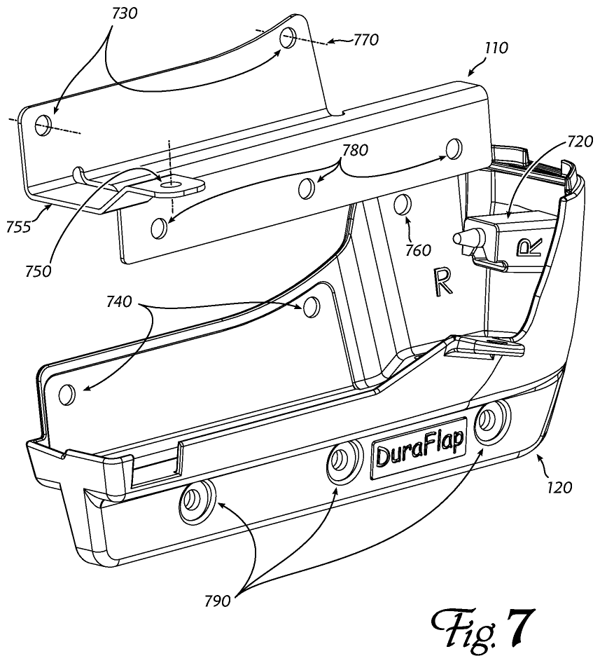

FIG. 7 is an exploded diagram of the embodiment shown in FIGS. 1 and 2. Mounting bracket 110 has been moved up so that its zig-zag bend (like FIG. 5, 520) is visible. Contoured shell or cowling 120 may have internal structure such as pylon 720, which may be similar to the internal structure of the OEM splash guard. Other internal structure such as ribs or braces (not shown) may be used to improve stiffness or manufacturability, but most of the strength of an embodiment is provided by the bracket 110.

Both the mounting bracket 110 and the contoured shell 120 comprise a number of holes. Some of the holes (e.g. 730 & 740) are aligned when the bracket and shell are assembled, and fasteners inserted through these holes secure both the bracket and the shell to the vehicle. Preferably, these holes are located similarly to holes for fasteners for an OEM splash guard, so that an embodiment can replace a splash guard with little or no modification to the vehicle.

Some mounting holes in the bracket (e.g. 750) may not correspond to a hole in the cowling 120; and some holes in the cowling (e.g. 760) may not correspond to a hole in the bracket 110. These holes may also be used to secure the embodiment to the vehicle, preferably in locations where a hole in the vehicle body already exists to accept a fastener. Mounting holes (whether for securing bracket only, cowling only, or bracket together with cowling) should have axes that are distributed at varying angles. For example, the axes of holes 730 and 740 (see broken line 770) are roughly perpendicular to the axis of hole 750. This distribution of mounting-fastener axes allows the embodiment to be secured with greater rigidity. If multiple fastener axes cannot be provided, then at least fastened surfaces should not all be in the same plane. For example, even if an embodiment could not accommodate a bracket support arm like 755, the securement provided by the fasteners at 730/740 (which are in one plane) could be supplemented by the fastener at 760, which is in a parallel plane that is displaced forward from the 730/740 plane.

An embodiment further comprises a plurality of holes 780, 790 which are aligned when the bracket 110 is assembled with the cowling 120. These holes accept fasteners to secure a mud flap to the structure, and thus to the vehicle at the aft portion of a wheel well.

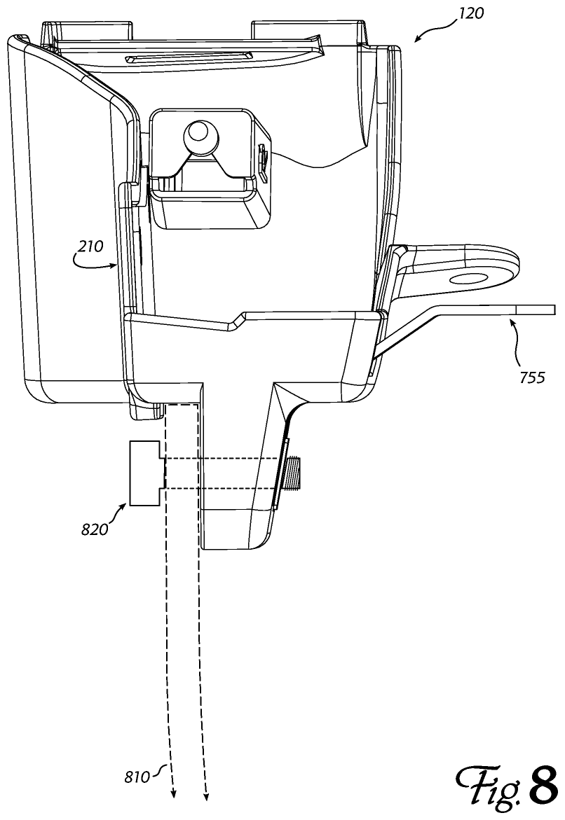

FIG. 8 shows a side view of an embodiment, depicted from the inside (i.e., from between the wheels of the vehicle, looking outward). The cowling 120 and the support arm 755 are visible. From this vantage point, one can see where a mudflap 810 would be secured to the embodiment by fasteners such as bolt 820. These fasteners pass through holes in an upper edge of the mud flap and through the holes indicated as 780 and 790 in FIG. 7. Thus, the mud flap is secured to both the support bracket 110 and the cowling 120. As depicted in FIG. 5, the front surface of the mud flap is roughly tangent with front face of the mounting structure 210 and the inner surface of the wheel well.

Mud flaps suitable for use with embodiments of the invention may be made of a sturdy, flexible plastic or polymer substance. A material around 0.375″ or 0.5″ in thickness may be appropriate for heavy-duty trucks and work vehicles. The appropriate length of a mud flap depends on the diameter of the wheels in use and the desired ground clearance. Selection of these parameters is within the capabilities of one of ordinary skill in the art. The same mounting structure (with bracket and cowling) can accommodate mud flaps of different lengths and thicknesses, and damaged mud flaps can be replaced without removing or disturbing the mounting structure.

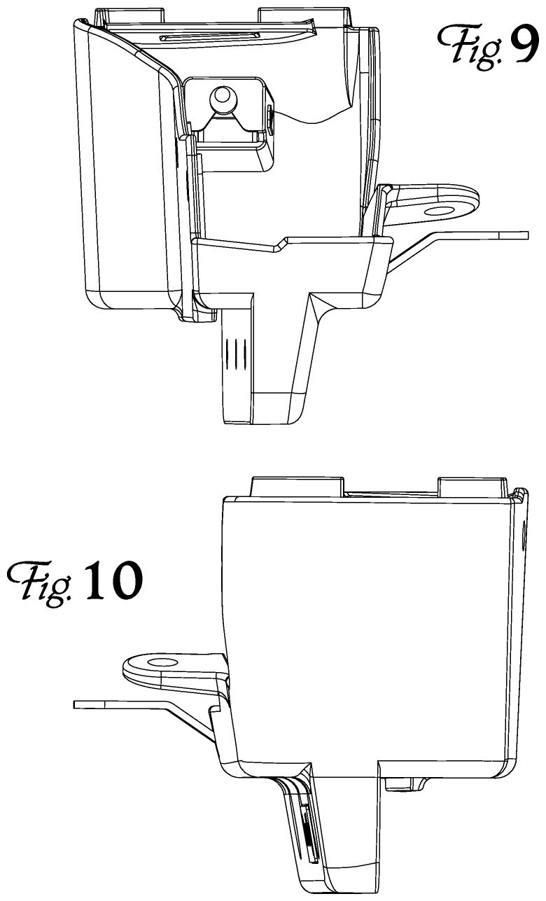

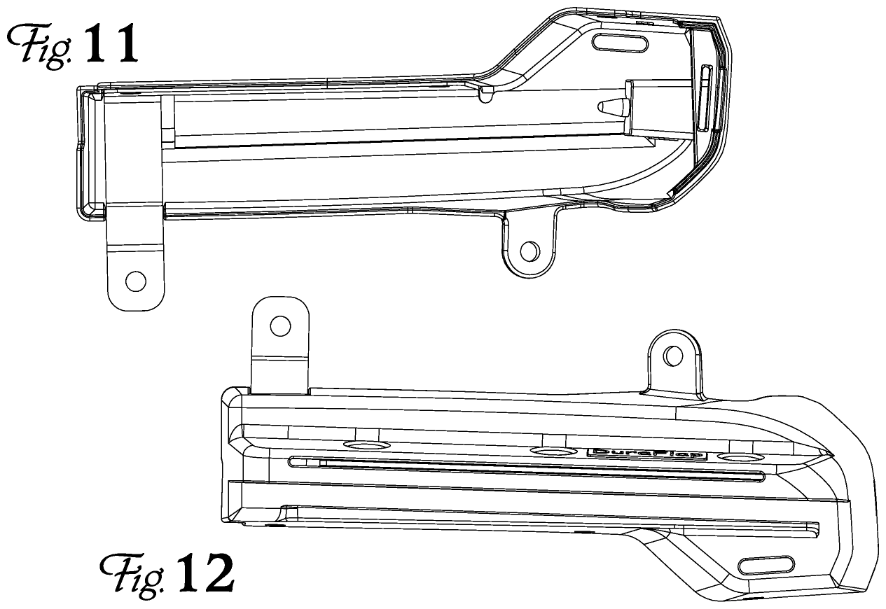

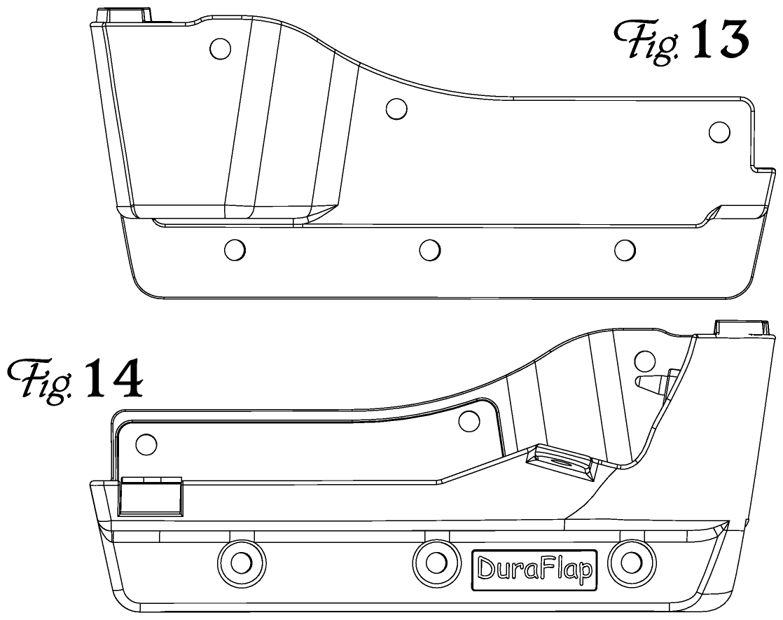

FIGS. 9-14 show elevations of an embodiment of the invention from six standard viewpoints. FIG. 9 is an inside view, similar to FIG. 8 but from a slightly different viewpoint. FIG. 10 is an outside view. FIG. 11 is a top view. FIG. 12 is a bottom view. FIG. 13 is a front view (i.e., a view from the front tire, looking toward the rear of the vehicle). FIG. 14 is a rear view. An embodiment suitable for the left front wheel well of this vehicle is a substantial, but not necessarily exact, mirror image of this structure.

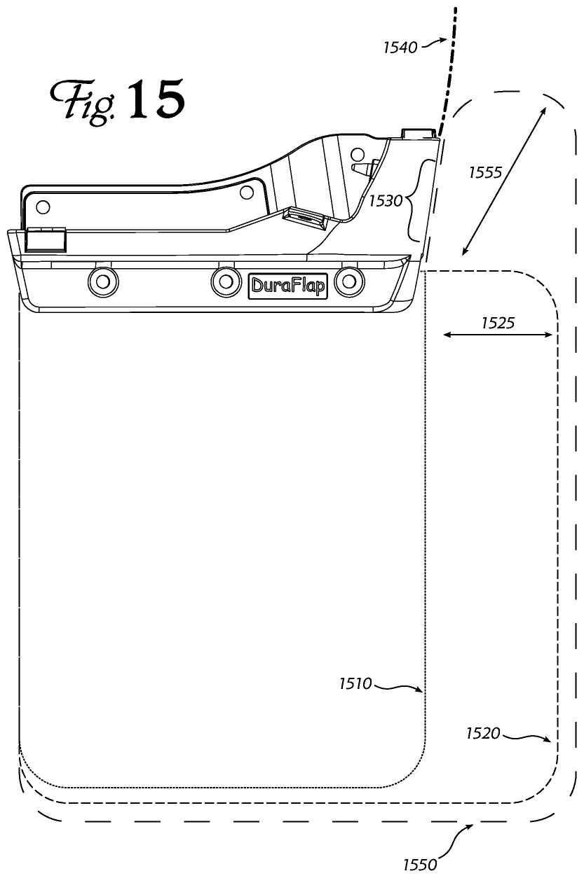

FIG. 15 shows an embodiment of the invention from the rear (i.e., from behind the wheel, looking forward in the ordinary direction of travel for the vehicle). A mud flap attached to the embodiment may be a simple rectangular sheet (1510, short dashes). However, if a vehicle has been fitted with larger or wider tires, or the wheels have been mounted on offsets to increase the track, then a wider mud flap (1510, medium dashes) may be mounted. Wider mud flap 1510 extends beyond the lateral surface of the embodiment 1530, and even beyond the lateral surface of the vehicle fender 1540, as shown by arrow 1525. For a vehicle with even larger or more-offset tires, a mud flap (1550, long dashes) may extend both laterally beyond the surface of the embodiment 1530 and the vehicle fender 1540, as well as vertically above the top of the embodiment, as shown by arrow 1555.

Note that wider and taller mud flaps as described here may assist with the vehicle's regulatory compliance. In some jurisdictions, an on-road vehicle may not be permitted to have tires extending beyond a lateral surface of the vehicle body by more than a prescribed amount. However, by extending the mud flaps laterally (as far or beyond the lateral outer surface of the tire, the “sidewall,”) the wider-tracked vehicle may be brought into compliance with the law. (In addition, these wider mud flaps may provide better protection from dirt and gravel, and may reduce the amount of debris that could harm nearby vehicles.)

The distinguishing characteristics of the present invention have been described largely by reference to specific examples and configurations for a particular vehicle. However, those of skill in the art will recognize that modular, multi-configurable mud flap mounting structures can also be constructed differently than herein described. Such variations and alternates are understood to be captured according to the following claims.

I claim:

1. A mudflap system for a wheel well of a vehicle, comprising:
a mounting bracket having a first plurality of holes aligned with fasteners in a wheel well of a vehicle and a second, distinct plurality of mounting holes;
a cowling to cover the mounting bracket; and
a mudflap having a plurality of mounting holes arranged to align with the second, distinct plurality of mounting holes, wherein
the cowling is shaped to extend a styling form of a vehicle fender adjacent the wheel well.

2. The mudflap adapter of claim 1 wherein the second, distinct plurality of mounting holes consists of three (3) mounting holes.

3. The mudflap adapter of claim 1 wherein the first plurality of holes and the second, distinct plurality of holes are all formed in a substantially planar surface of the mounting bracket.

4. The mudflap adapter of claim 1 wherein the first plurality of holes and the second, distinct plurality of holes are offset by approximately a thickness of the mudflap.

5. The mudflap adapter of claim 1 wherein the mounting bracket is formed of metal, and the cowling is formed of plastic.

6. The mudflap adapter of claim 1 wherein the cowling is configured to replace an OEM trim piece installed at a lower rear portion of the wheel well.

7. The mudflap adapter of claim 1 wherein the cowling comprises a third plurality of holes, and wherein
at least one hole of the first plurality of holes is aligned with at least one hole of the third plurality of holes so that a single fastener can pass through the at least one hole of the first plurality of holes, the at least one hole of the third plurality of holes, and an existing hole in the wheel well of the vehicle.

8. The mudflap adapter of claim 1 wherein the cowling comprises a third plurality of holes, and wherein
at least a first fastener to secure the mudflap adapter to the wheel well of the vehicle passes through only the cowling;
at least a second fastener to secure the mudflap adapter to the wheel well of the vehicle passes only through the mounting bracket; and
at least a third fastener to secure the mudflap adapter to the wheel well of the vehicle passes through both the cowling and the mounting bracket.

9. The mudflap adapter of claim 1 wherein at least two fasteners secure the mudflap adapter to the wheel well of the vehicle, and wherein
an axis of a first fastener of the at least two fasteners is not parallel to an axis of a second fastener of the at least two fasteners.

10. The mudflap adapter of claim 9 wherein the axis of the first fastener of the at least two fasteners is perpendicular to the axis of the second fastener of the at least two fasteners.

11. A mudflap adapter for securing a mudflap near a wheel well of a vehicle, comprising:
a plastic cowling to replace a trim piece provided at the wheel well of the vehicle;
a mounting bracket substantially covered by the plastic cowling; and
a mud flap, wherein
the plastic cowling and the mounting bracket are secured to the wheel well of the vehicle by a first plurality of fasteners, and
the mud flap is secured to the plastic cowling and the mounting bracket by a second, distinct plurality of fasteners, and wherein
a first fastener of the first plurality of fasteners secures only the cowling to the wheel well of the vehicle,
a second fastener of the first plurality of fasteners secures only the mounting bracket to the wheel well of the vehicle, and
a third fastener of the first plurality of fasteners secures both the cowling and the mounting bracket to the wheel well of the vehicle.

12. The mudflap adapter of claim 11 wherein axes of the first plurality of fasteners are not all parallel.

13. The mudflap adapter of claim 11 wherein an axis of a first fastener of the first plurality of fasteners is perpendicular to an axis of a second fastener of the first plurality of fasteners.

14. The mudflap adapter of claim 11 wherein an outer edge of the mudflap is approximately aligned with an outer surface of the plastic cowling.

15. The mudflap adapter of claim 11 wherein an outer edge of the mudflap extends laterally beyond an outer surface of the plastic cowling.

16. The mudflap adapter of claim 11 wherein an upper extent of the mudflap extends above an upper edge of the plastic cowling.

17. The mudflap adapter of claim 11 wherein an outer edge of the mudflap extends at least as far as a lateral outer surface of a tire of the vehicle.
